(19) United States
(12) Patent Application Publication
(10) Pub. No.: US 2005/0060444 A1
(43) Pub. Date: Mar. 17, 2005

(54) Rugged computing module

(75) Inventor: Jackson Lum, Roslyn, NY (US)

Correspondence Address: HOFFMANN & BARON, LLP, 6900 JERICHO TURNPIKE, SYOSSET, NY, 11791, US

(73) Assignee: Logic Controls, Inc

(21) Appl. No.: 10/662,120

(22) Filed: Sep. 12, 2003

(51) Int. Cl. G06F 3/00

(52) U.S. Cl. 710/36

(57) ABSTRACT

A rugged computing module includes a microcontroller, flash memory, and at least one interface port. The flash memory is operatively coupled to the microcontroller, and at least a portion of the flash memory is used as a substitute for disk drive storage area, thereby eliminating moving parts in the computing module. The interface port is operatively coupled to the microcontroller and includes at least one of an Ethernet port, a Universal Serial Bus (USB) port, a serial port, a parallel port, a keyboard/mouse port, and a Super Video Graphics Array (SVGA) port.

### BACKGROUND OF THE INVENTION

1. Field of the Invention

The present invention relates generally to computers and more specifically relates to a compact, full feature, rugged, and reliable computing module having interfaces, memory capacity, and performance that are cost-optimized for use in a wide variety of industrial applications.

2. Description of the Related Art

The advances made in computers for personal, industrial, and military applications have been vast. These improvements include new and enhanced parallel, serial, and network interfaces, increased fixed and removable storage capacity; enhanced video, graphic, and audio processing; and operating systems that are substantially more powerful. However, the most notable achievements have been in providing greater processing speed and memory capacity.

Gordon Moore, a co-founder of Intel Corporation, made an observation in 1965 that the number of transistors per square inch on integrated circuits had doubled every year since the integrated circuit was invented. Moore predicted that this trend would continue for the foreseeable future. Although the rate observed by Moore has decreased since 1965, data density has doubled approximately every 18 months, and this remains the current definition of Moore's Law.

The primary driving force in the computer industry has been to maximize speed and memory capacity in any computer solution that satisfies the customer's needs, whether that customer is an individual dreaming of the ultimate system for lifelike interactive games and multimedia applications, or a corporate user trying to find a low cost solution for relatively simple control functions. As a result, the majority of computers sold today incorporate the most advanced features. Although this may well be enticing to the individual consumer who typically buys one system every four to six years, it is inappropriate and costly for the industrial user who purchases in larger quantities with the hope for a substantially longer useful life.

In addition, for many industrial dedicated applications, small but rugged computers are desirable. In most cases, computer manufacturers simply package a full-feature computer into a smaller footprint. With significantly lower sales volume, when compared with popular consumer computers, the price of these low-volume small computers become exceedingly high.

Accordingly, there remains a need in the field of computer systems for an alternative computing module tailored to requirements that are essential to industrial applications, such as factory automation, health care, patient monitoring, airline counter ticketing, tracking services, and point-of-sale (POS) terminals.

It is another goal of the present invention to provide a computing module that incorporates interfaces, memory capacity, and performance that are cost-optimized for a wide variety of industrial applications without many of the advanced features that are underutilized in such applications.

It is yet another goal of the present invention to provide an industrial computing module that is compact, lightweight, rugged, reliable, and generically applicable to the majority of industrial applications.

It is a further goal of the present invention to provide a computing module that is highly integrated to minimize the required number of peripheral components.

It is still a further goal of the present invention to provide a computing module that incorporates the minimum number of interfaces that are most utilized in industrial applications.

It is yet a further goal of the present invention to provide a computing module that includes a cost-effective central processing unit that satisfies the majority of industrial applications.

### SUMMARY OF THE INVENTION

The foregoing needs, purposes, and goals are satisfied in accordance with the present invention, which, in one embodiment, provides a rugged computing module that includes a microcontroller, flash memory, and interface ports. The flash memory is operatively coupled to the microcontroller and at least a portion of the flash memory is adapted for use as a substitute for hard drive storage area, which substantially eliminates moving parts in the computing module.

The interface port is operatively coupled to the microcontroller and includes at least one of an Ethernet port, a Universal Serial Bus (USB) port, a serial port, a parallel port, a keyboard/mouse port, a Super Video Graphics Array (SVGA) port, an Infrared (IR) port, a Bluetooth port, and a wireless port.

A housing substantially encloses the computing module circuitry and preferably functions as a heat sink. Power supply components are preferably disposed external to the housing to reduce heat dissipation. The computing module may be adapted for use in point-of-sale (POS), restaurant, workstation, automatic identification, factory automation, health care, patient monitoring, airline counter ticketing, and tracking applications.

These and other purposes, goals and advantages of the present invention will become apparent from the following detailed description of illustrative embodiments thereof, which is to be read in connection with the accompanying drawings.

### BRIEF DESCRIPTION OF THE DRAWINGS

FIG. 1 is a top perspective view of the computing module formed in accordance with the present invention.

FIG. 2 is a front view of the computing module formed in accordance with the present invention.

FIG. 3 is a rear view of the computing module formed in accordance with the present invention.

FIG. 4 is a functional block diagram of the computing module formed in accordance with the present invention.

### DETAILED DESCRIPTION OF THE PREFERRED EMBODIMENTS

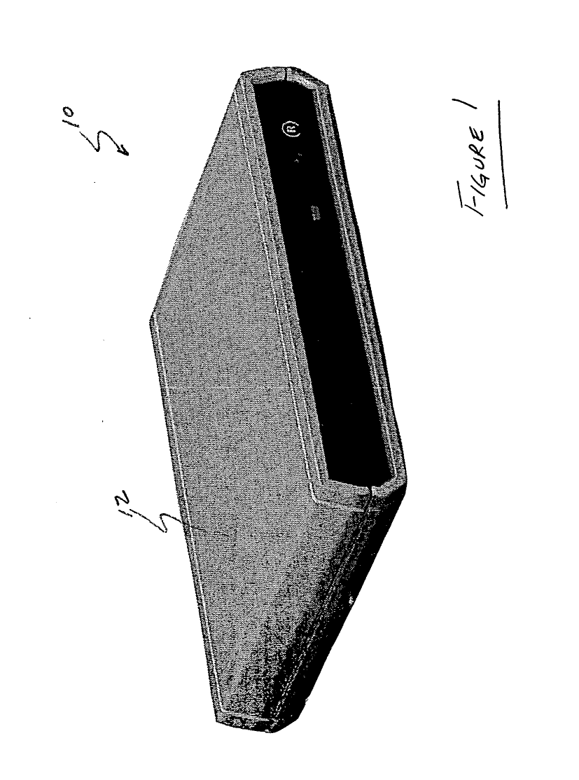

In accordance with the preferred embodiments contemplated as being within the scope of the present invention, FIG. 1 is a top perspective view of a computing module 10. The computing module 10 includes an external housing 12, which is preferably die cast from zinc and substantially restricts airflow to circuitry within the housing 12. The housing 12 is preferably used as a heat sink for the computing module 10. If the surface area of the housing 12 is expressed in square units, such as X in², and the volume of the housing is expressed in cubic units, Y in³, then X is preferably greater than Y.

The housing 12 is preferably about 6.3 inches in width, 1.0 inch in height, and 5.1 inches in depth. The weight of the computing module 10 is about 2.15 pounds and the operating temperature is preferably about 5° C. to 40° C. with a storage temperature of about 0° C. to 60° C. Two mounting brackets (not shown) are preferably provided on the bottom of the housing 12 so that the computing module 10 may be mounted to a wall, ceiling, tabletop, counter, and the like. It is to be understood that the physical characteristics of the computing module are not critical, are merely provided as an example, and are not intended to limit the scope of the present invention in any manner.

The computing module 10 preferably includes components that are mounted on a single printed circuit board (PCB) within the external housing 12 with no moving mechanical parts, such as a fan or a disk drive. Flash memory is preferably used as a substitute for hard drive storage area.

The computing module 10 formed in accordance with the present invention preferably includes an Intel® compatible x86-based microcontroller, which is Windows® compatible and able to run Linux® based applications. The microcontroller is preferably provided with a clock that satisfies a minimum requirement of an application to reduce heat dissipation and cost. It is anticipated that the computing module 10 would be suitable for use in a wide variety of industrial applications, such as restaurant kitchen systems, point of sale (POS) systems, work stations, automatic identification systems, airline counter ticketing, tracking services, factory automation, healthcare and patient monitoring systems, and the like.

The computing module 10 also preferably provides interface capabilities, such as an Ethernet port, a Universal Serial Bus (USB) port, serial (RS-232) ports, a PS/2 keyboard/mouse port, and an SVGA (super video graphics array) port. Additional wired and wireless interface capabilities, such as infrared and Bluetooth, are contemplated to be within the scope of the present invention. The Ethernet port permits full access to the Internet, file transfer, and system networking resources. The USB port enables the computing module 10 to drive multiple peripheral devices and host a wide variety of application software.

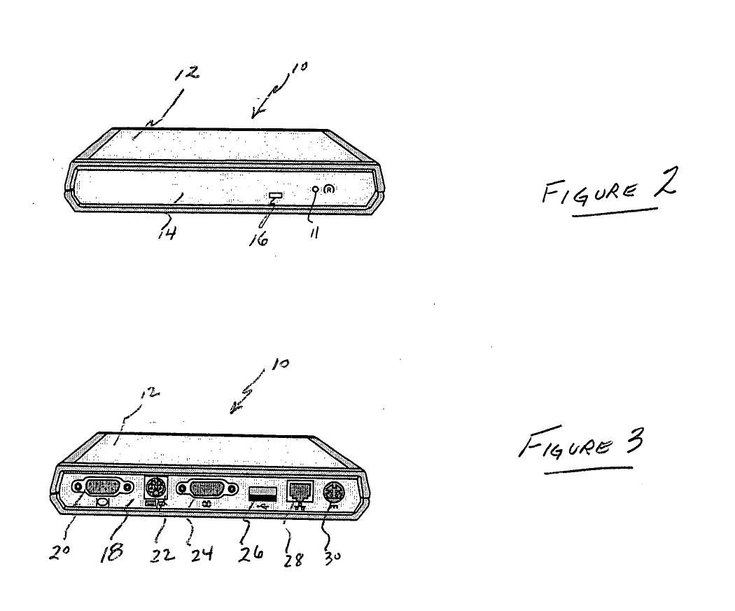

FIG. 2 is a front view of the computing module 10 formed in accordance with the present invention. The computing module 10 includes a front panel 14, through which a power light emitting diode (LED) 16 is disposed. The power LED 16 preferably indicates whether the computing module 10 is powered and operational. A reset switch on the printed circuit board is accessible through an aperture 11 in the housing 12 by using commonly objects, such as a ballpoint pen.

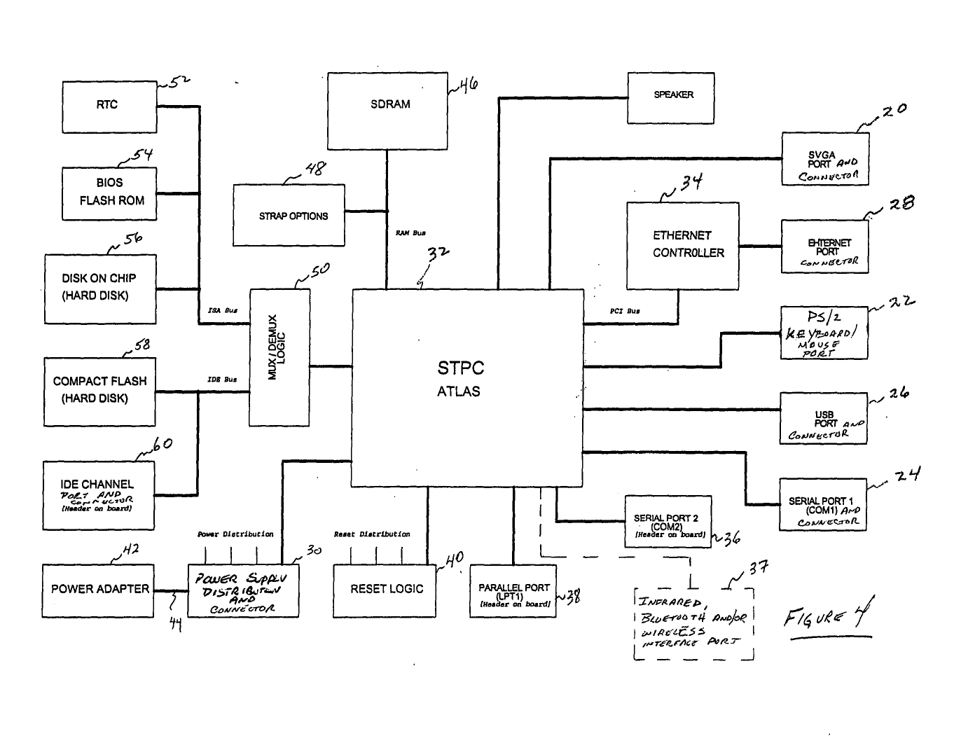

A rear view of the computing module 10 is shown in FIG. 3. The computing module 10 includes a rear panel 18, through which various interface connectors are disposed. The interface connectors preferably include an SVGA port connector 20, a PS/2 keyboard/mouse port connector 22, a serial port connector 24, a USB port connector 26, an Ethernet port connector 28, and a power adapter connector 30.

FIG. 4 is a block diagram of a preferred circuit implementation of the computing module 10 shown in FIGS. 1-3. The circuitry preferably includes an STPC12HEYC microcontroller 32 operating at 133 MHz, which is a 516-pin ball grid array (BGA) package that is commercially available from ST Microelectronics, 1000 East Bell Road, Phoenix, Ariz. 85022. The microcontroller 32 is operatively coupled to an STE10/100A Ethernet controller 34 and HB626-1 Ethernet magnetics, which are also commercially available from ST Microelectronics. The Ethernet controller 34 is operatively coupled to the Ethernet port connector 28.

The microcontroller 32 preferably also interfaces with the SVGA port and connector 20, PS/2 keyboard/mouse port and connector 22, USB port and connector 26, and the serial port and connector 24, the ports of which are shown in FIG. 3. The SVGA port preferably supports 1280×1024 pixels with 4 MB of video ram that supports up to 16 million colors. The microcontroller 32 preferably interfaces with the Ethernet controller 34 through a peripheral component interconnect (PCI) bus.

The microcontroller 32 also preferably interfaces to an auxiliary serial port 36, an auxiliary parallel port 38, and an integrated development environment (IDE) channel port and connector 60. Access to these ports is preferably provided by headers on the printed circuit board. Additional wireless interface ports 37, such as Infrared (IR) and Bluetooth Reset may also be included in the computing module. Reset logic 40, which is operatively coupled to and controlled by the microcontroller 32, preferably provides a suitable reset signal for various portions of the computing module circuitry.

The microcontroller 32 is also operatively coupled to a power supply distribution and connector assembly 30, which preferably inputs various direct current (dc) supply voltages from the power supply connector 30 located on the rear panel 18 of the computing module 10 shown in FIG. 3. Voltage converters and regulators are preferably located in a power adaptor 42, which is coupled to the power supply distribution and connector assembly 30. The power adapter 42 is preferably located external to the housing 12 and coupled to the power supply distribution and connector assembly 30 through a power cord 44.

As shown in FIG. 4, the computing module circuitry preferably includes synchronous dynamic random access memory (SDRAM) 46, which is operatively coupled to the microcontroller 32. The SDRAM 46 may be implemented using IS42S16400A-10T/7T 1M×16×4 SDRAM devices, which are commercially available from Integrated Silicon Solution, Inc. located at 2231 Lawson Lane, Santa Clara, Calif. 95054. The computing module 10 preferably supports about 32 MB to 128 MB of SDRAM.

Various hardware programmable features are preferably selected by manipulation of jumpers in a strap options 48 circuit, which is operatively coupled to the microcontroller 32. The remaining devices shown in FIG. 4, which are preferably accessed by the microcontroller 32 through multiplexor/demultiplexor logic circuitry 50, include a real time clock 52, a BIOS flash ROM 54, a Disk-on-Chip 56, compact flash 58, and an Integrated Development Environment (IDE) channel port and connector 60. The logic circuit 50 preferably provides address, data, and control interfaces between the microcontroller 32, peripheral devices, and memory.

The real time clock 52 is preferably implemented with an M48T86 MH device, which is commercially available from ST Microelectronics. The BIOS flash ROM 54 is preferably implemented using AT49F002N70JC devices, which are commercially available from Atmel Corporation located at 2325 Orchid Park Way, San Jose, Calif. 95131, or SST39SF020A devices, which are commercially available from SST located at 1171 Sonora Court, Sunnyvale, Calif. 94086.

The Disk-on-Chip flash memory 56 is preferably implemented with a Disk-on-Chip 2000, which is commercially available from M-Systems, Inc. located at 8371 Central Avenue, Suite A, Newark, Calif. 94560. The Disk-on-Chip 56 provides a solid-state alternative to hard drive storage areas to increase reliability by eliminating moving parts in the computing module 10. The Disk-on-Chip 56 and the compact flash 58 provide a solid-state storage area of about 16 MB to more than 4 GB and are preferably selected to satisfy a minimum requirement of the intended application. However, since it is contemplated that the density of memory, such as that provided by flash memory, will increase dramatically in the future in accordance with technological advances, all memory capacities set forth herein are merely intended as an example without limiting the scope of the present invention in any manner.

The real time clock 52, BIOS flash ROM 54, and Disk-on-Chip 56 are preferably accessed through an industry standard architecture (ISA) bus coupled to the microcontroller 32 through the logic circuit 50. The compact flash 58 is preferably implemented by a THNCFxxx MBA compact flash card, which is commercially available from Toshiba America Electronic Components, Inc. located at 2035 Lincoln Highway, Suite 3000, Edison, N.J. 08817. Both the compact flash 58 and IDE channel port and connector 60 are preferably coupled by an integrated development environment (IDE) bus to the microcontroller 32 through the logic circuit 50. The IDE channel port and connector 60 preferably provide the microcontroller 32 with access to an external hard drive storage area through a header or connector on the printed circuit board.

The SVGA port connector is preferably implemented with a DB15 female connector. The PS/2 keyboard/mouse port connector is preferably a mini-DIN6 female connector. The serial port connector is preferably a DB9 male connector. The USB port connector is preferably a standard USB type B connector. The Ethernet port is preferably an RJ45 8-pin female connector, and the power supply connector is preferably a shielded snap lock mini-DIN with EMI/RFI suppression female connector.

Therefore, a rugged computing module formed in accordance with the present invention is tailored to requirements that are essential to industrial applications, such as factory automation, health care, patient monitoring, and airline counter ticketing. The computing module incorporates interfaces, memory capacity, and performance that are cost-optimized for a wide variety of industrial applications without many of the advanced features that are underutilized in such applications.

Although illustrative embodiments of the present invention have been described herein with reference to the accompanying drawings, it is to be understood that the invention is not limited to those precise embodiments, and that various other changes and modifications may be provided therein by one skilled in the art without departing from the scope or spirit of the invention.

1. A rugged computing module comprising:
a microcontroller;
flash memory, the flash memory being operatively coupled to the microcontroller, at least a portion of the flash memory being adapted for use as a substitute for disk drive storage area, thereby eliminating moving parts in the computing module; and
at least one interface port, the at least one interface port being operatively coupled to the microcontroller, the at least one interface port including at least one of an Ethernet port, a Universal Serial Bus (USB) port, a serial port, a parallel port, a keyboard/mouse port, a Super Video Graphics Array (SVGA) port, an Infrared (IR) port, a Bluetooth port, and a wireless port.

2. A rugged computing module as defined by claim 1, further comprising dynamic random access memory (RAM), the dynamic RAM being operatively coupled to the microcontroller, the dynamic RAM being used as volatile storage area for data and variables.

3. A rugged computing module as defined by claim 1, further comprising an Integrated Development Environment (IDE) channel port, the IDE channel port being operatively coupled to the microcontroller, the IDE channel port being adapted for providing an interface between the computing module and disk drive storage area external to the computing module.

4. A rugged computing module as defined by claim 1, further comprising a housing, the housing substantially enclosing the computing module.

5. A rugged computing module as defined by claim 4, further comprising a power supply, the power supply being disposed external to the housing.

6. A rugged computing module as defined by claim 4, wherein the housing substantially restricts airflow to the computing module.

7. A rugged computing module as defined by claim 4, wherein the housing is adapted to be used as a heat sink for the computing module.

8. A rugged computing module as defined by claim 4, wherein the housing further comprises a surface area and a volume, the surface area being expressed as X units² and the volume being expressed Y units³, X being greater than Y.

9. A rugged computing module as defined by claim 1, further comprising at least one bracket, the at least one bracket being adapted for mounting the computing module.

10. A rugged computing module as defined by claim 1, further comprising a real time clock circuit, the real time clock circuit being operatively coupled to the microcontroller, the real time clock circuit adapted to provide a time of day.

11. A rugged computing module as defined by claim 1, wherein the microcontroller is operatively coupled to a clock signal, the clock signal having a frequency that determines a speed at which the microcontroller operates, the frequency of the clock signal being adapted to satisfy a minimum requirement of an application.

12. A rugged computing module as defined by claim 1, wherein a quantity of flash memory is selected to satisfy a minimum requirement of an application.

13. A rugged computing module as defined by claim 1, wherein the computing module is adapted for use in at least one of a point-of-sale (POS) application, restaurant application, a workstation application, automatic identification application, factory automation application, health care application, patient monitoring application, airline counter ticketing application, and tracking application.

14. A rugged computing module as defined by claim 1, wherein the computing module is adapted for use in industrial applications.

15. A rugged computing module comprising:
a microcontroller, the microcontroller being operatively coupled to a clock signal, the clock signal having a frequency that determines a speed at which the microcontroller operates, the frequency of the clock signal being adapted to satisfy a minimum requirement of an application;
flash memory, the flash memory being operatively coupled to the microcontroller, at least a portion of the flash memory being adapted for use as a substitute for disk drive storage area, thereby eliminating moving parts in the computing module, a quantity of the flash memory being selected to satisfy a minimum requirement of an application;
at least one interface port, the at least one interface port being operatively coupled to the microcontroller, the at least one interface port including at least one of an Ethernet port, a Universal Serial Bus (USB) port, a serial port, a parallel port, a keyboard/mouse port, a Super Video Graphics Array (SVGA) port, an Infrared (IR) port, a Bluetooth port, and a wireless port; and
a housing, the housing substantially enclosing the computing module, the housing being adapted to provide a heat sink for the computing module.

16. A rugged computing module as defined by claim 4, wherein the housing includes a rugged die cast case.

17. A rugged computing module as defined by claim 16, wherein the rugged die cast case is manufactured from zinc.

18. A rugged computing module as defined by claim 15, wherein the housing includes a rugged die cast case.

19. A rugged computing module as defined by claim 18, wherein the rugged die cast case is manufactured from zinc.
